(19) United States
(12) Patent Application Publication
(10) Pub. No.: US 2024/0330865 A1
(43) Pub. Date: Oct. 3, 2024

(54) SYSTEM AND METHOD OF COOPERATIVELY OPTIMIZING COMPENSATION BENEFITS FOR EMPLOYER AND WORKER

(71) Applicant: Thomas Hecht, Wilbraham, MA (US)

(72) Inventor: Thomas Hecht, Wilbraham, MA (US)

(21) Appl. No.: 18/128,041

(22) Filed: Mar. 29, 2023

(51) Int. Cl. G06Q 10/1057

(52) U.S. Cl. CPC G06Q 10/1057

(57) ABSTRACT

A method for ensuring fairness in compensation to employees and contractors is provided comprising a computer determining a total budgeted cost for a time period associated with a job description. The method also comprises the computer subtracting non-cash costs from the budgeted cost for exempt employees subject to the description to calculate an employee periodic cash cost. The method also comprises the computer subtracting non-cash costs from the budgeted cost for non-exempt employees subject to the description to calculate a contractor periodic cash cost. The method also comprises the computer determining an annual salary for employees based on the employee periodic cash cost. The method also comprises the computer determining a bi-weekly wage for contractors based on the contractor periodic cash cost. The method also comprises the computer publishing annual salary information and bi-weekly wage information for use in communication regarding compensation and benefits of employee status and contractor status.

### CROSS REFERENCE WITH RELATED APPLICATIONS

None

### FIELD OF THE DISCLOSURE

The present disclosure is in the field of worker compensation and benefits. More particularly, the present disclosure describes systems and methods of adopting a holistic approach to total compensation and worker relations and thereby facilitate transition for workers between employee status and contractor status to better meet the needs of both employer and worker population flexibly and cooperatively.

### BACKGROUND

An employee is a worker on a company's payroll who receives wages and benefits in exchange for following the organization's guidelines and remaining loyal. A contractor is an independent worker who has autonomy and flexibility but does not receive benefits such as health insurance and paid time off.

Work environments in many developed countries have changed, particularly since the arrival of Covid-19 and related pandemics and labor shortages, such that workers are demanding more flexibility in their work life and in compensation structures. Even prior to the pandemics that began in 2020, relationships between employers and workers had changed. The wave of mass layoffs and downsizings that began in the 1990s, much of which impacted longtime employees with good work records, caused salaried employees to rethink the idea of loyalty to employer which had become a hallmark of the American economy and G7 group of Western economies beginning in the post-war era.

With globalization and as US employers have transitioned toward “Sun Belt” locations and their at-will employment environments and union-unfriendly settings, and away from pension and defined benefit retirement structures, the relationship between employer and worker has fundamentally shifted in the last thirty years. Particularly with at-will employment wherein a good worker can lose his/her job for no reason, employees no longer feel the type of loyalty toward employer of earlier generation with forty-year careers with a single employer and gold watch and pension upon retirement.

### BRIEF DESCRIPTION OF THE FIGURE

FIG. 1 is a block diagram of a system of cooperatively optimizing compensation benefits for employer and worker according to an embodiment of the present disclosure.

### DETAILED DESCRIPTION

Systems and methods described herein provide for an employer to view total worker compensation as a gross or top-level number or benefit that may be distributed in different ways and which optimizes salary, hourly wage, and other benefits within that number. Workers are empowered to transition freely and seamlessly between employee and contractor status, within applicable regulations, to optimize economic and personal benefit for themselves based on their own set of circumstances. Employers similarly work within the system and, subject to regulations and practical limitations, seek to optimize benefit for themselves, benefit which includes attracting and retaining high quality workers, whether salaried employees or hourly contractors.

At different times and under varying sets of economic, legal, tax, and political conditions it may make sense for a worker to be a legal employee of a company or other employer. At other times and under other conditions, contractor status make more sense. The same is true for the employer. Under varying conditions, employee status or contractor status may be more preferable for different job types.

Systems and methods provided herein give workers flexibility to alternate between or straddle employee/W-2 status and contractor/1099 status on a real-time basis. A worker may be an employee covered by W-2 reporting one week and a contractor, subject to 1099 reporting, the next. For most employers, work has ebbs and flows. It is therefore logical that a 40-hour workweek doesn't perfectly match a standard workload. Similarly, businesses go through cycles. Wages generally scale literally. The present disclosure may be viewed as a compensation method to better match production and compensation.

Systems and methods may in effect create a new class of worker that has the flexibility to maximize the benefits of a contractor work or salaried work while diluting or minimizing the disadvantages. Labor markets have changed with the prevalence of remote workers, the “gig” economy, and shared workspaces.

The changing nature of work has caused relationships between employer and worker to change. More fluidity and flexibility are necessary as boundaries between employer and worker change and definitions of what constitutes employment also rapidly change. At times, it may be to the advantage of an employer for some workers to be employees and others to be contractors, depending on job type. The mix may change under other conditions. Systems and methods calculate advantages of employee status and contractor status for specific job descriptions, locations, and other factors, advantages for both the worker and the company or other employer.

Employers may, in times of post-Covid labor shortages, recognize the need to be more accommodating to workers regarding scheduling, work from home options, and needs for more flexible and varied types of compensation. Particularly with flexibility in types of compensation, employers may find that adopting and promoting flexible policies toward worker type and compensation may make them more desirable to workers and hence at an advantage in the workplace in attracting talented people.

Systems and methods provided herein may be characterized as a framework for value exchange to match stakeholder constraints and interests. Stakeholders, comprising at least employers and workers, may realize that they are both invested in the same endeavor such that it is best to cooperate in striking a balance with work and benefits, enabling both to achieve objectives and prosper. The system allows the stakeholders to reach that balance equitably.

At a high level, both sides of the transaction, employer, and worker, input their needs and constraints. The application optimizes or makes recommendations about transactions to maximize tax efficient benefits and employment structures, either employee or contractor, for both employer and worker.

In addition to facilitating transition between employee and contractor status, employers may also benefit when workers, whether salaried or contractor, are given the opportunity to acquire equity or stock in their employer. Systems and methods may further offer private loans for employees to participate in employee stock purchase plans (ESPP) plans. Such a benefit may be provided as a line of credit that a qualified employee or contractor may draw upon on an ad hoc basis within the constraints of their ESPP plan or what could be their 401k matching benefit. They would use the drawn funds to purchase company equity under their plan. Employers might incentivize workers to use this benefit by offering such private loans at interest rates and/or repayment and other terms that are attractive or allowing stock purchases at below market prices with rules about subsequent liquidation.

Tax implications are an important part of the present disclosure. Applications and algorithms used by the system place significant emphasis on tax considerations of each alternative made available to workers. These considerations include tax impact on both worker considering alternatives as well as employer offering the alternatives.

Contractors have more flexibility with deducting expenses and have that advantage over salaried employees. Gains on ESPP plans may not be subject to payroll taxes. Other benefits offer lesser tax advantages such as Health Reimbursement Arrangements (HRA), employer-funded group health plans from which employees are reimbursed tax-free for qualified medical expenses.

A further ongoing deficiency in benefits is in healthcare. In the US, the Affordable Care Act mandates requirements for employers to provide healthcare with a minimum standard. However, in the case of a family where both spouses are employed, one employer may benefit while the other employer may suffer. For example, if one employer subsidized $7,500 for healthcare and the other employer offers a better plan with a $10,000 subsidy, the first employer comes out ahead and the second employer suffers for offering a better benefit.

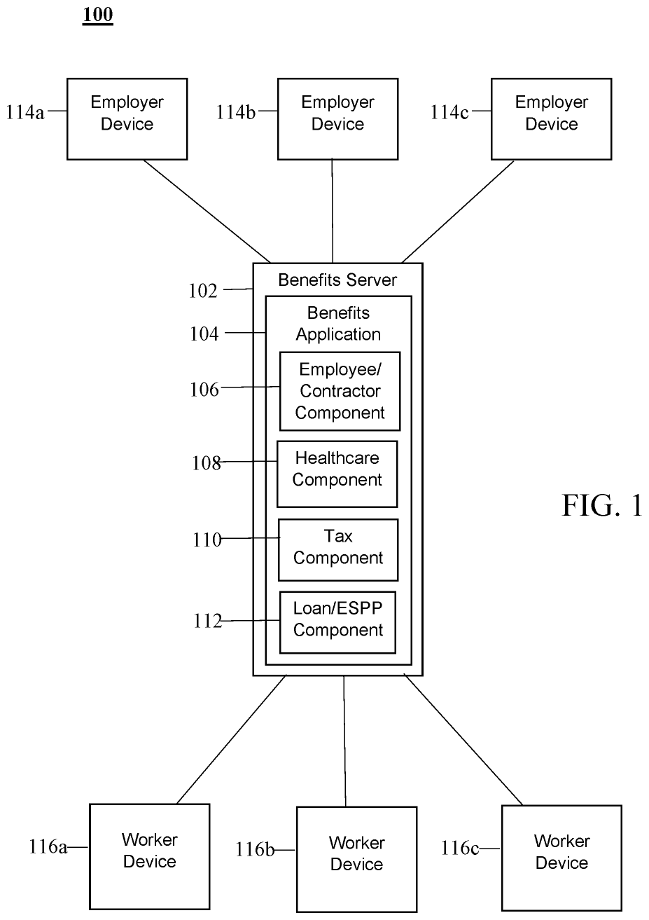

Turning to the FIGURE, FIG. 1 is a block diagram of a system of cooperatively optimizing compensation benefits for employer and worker according to an embodiment of the present disclosure. FIG. 1 illustrates components and relationships of system 100 of such optimizing of benefits for both parties.

System 100 comprises a benefits server 102 and a benefits application 104, referred to hereinafter respectively for brevity as the server 102 and the application 104.

The server 102 comprises at least one physical computer that may be located at multiple geographic locations. The application 104 comprises a plurality of software applications and files.

The system 100 also comprises components of the application 104 that comprise an employee/contractor component 106, a healthcare component 108, a tax component 110, and a loan/ESPP component 112. As their names suggest, each of these components 106-112 may comprise specialized algorithms that handle various aspects of computations as described above in detail.

The system 100 also comprises employer devices 114a-c used by managers and other administrative personnel of a company or other employer to access the server 102 and application 104. There, these users enter information and manipulate algorithms and variables to make determinations about offering different types compensation to different job types, and whether the job type should be employee, contractor, or either. With varying permission levels, users of employer devices 114a-c can view information made available by the employee/contractor component 106, the healthcare component 108, the tax component 110, and the loan/ESPP component 112 and access algorithms provided by each of the components 106-112 to run various simulations and make determinations about compensation offerings. These determinations include whether and when to offer a prospective worker a position under employee or contractor arrangement and whether to allow workers to transition from employee status to contractor status or vice versa.

The system 100 also comprises worker devices 116a-c in possession of persons who are either employees or contractors of a company or other organization or entity operating the server 102. Depending on a worker's status as employee or contractor and depending on the worker's job title and other factors, the worker will have various privileges to enter preferences, requests, changes, and other actions. At various times a worker may be authorized to enter requests to transition one status to another and at other times the worker may be barred from doing so. The worker may use his/her worker device 116a to make requests for loans under an ESPP program to purchase stock within limitations mandated by the program. In some cases, worker devices 116a-c may be desktop computers, laptop computers, or mobile devices operating internet browser software to log into the server 102 over the internet and access the application 104 in that manner.

In an embodiment, an employer using the teachings provided herein and the system 100 may be establishing a compensation structure for a particular job description. The job may either be a newly created position or an existing position wherein the structure is under review. The employer may, for example, be expanding or reducing headcount for the position. The employer may have a total gross budgeted amount for the position, the total pretax budgeted amount for the position including all benefits. The employer intends to either establish or convert the position as both an employee, exempt position as well as a contractor, non-exempt position.

In the embodiment, the employer determines non-cash benefits and tax considerations for both the employee and contractor options, considering factors such as federal, state, and local tax income tax rates, healthcare costs, cost of living factors for locales, and out-of-pocket expenses. After deducting non-cash benefits and accounting for tax considerations, the employer arrives at a bottom line amount to be remitted on a periodic basis to the employee or contractor. These amounts should roughly equate as the computations take into account as many known and estimated factors available to the employer. If the amounts seem out of line and potentially a cause for difficulty among workers, the employer may make changes as the system 100 permits modeling of compensations structures. Each of the employee/contractor component 106, the healthcare component 108, the tax component 110, and the loan/ESPP component 112 may be manipulated as the employer is designing compensation structures.

In another embodiment, when workers seek to transition from employee status to contractor status, in some cases the worker may be subject to an adverse compensation situation due to factors not apparent when compensation structures were set or due to factors specific to that worker's own situation. In such cases, the employer may offer the worker an opportunity to take advantage of the employer's ESPP plan to purchase equity in the employer to make up for any perceived difference in compensation. Further, ownership of equity in the employer may boost loyalty by the worker and increase the worker's interest in overall well-being of the employer. The system 100 and particularly the loan/ESPP component 112 of the application 104 assists in calculations associated with this embodiment.

As noted, the teachings of the present disclosure are heavily predicated on a new cooperation between employers and workers, whether the workers are employees or contractors. In addition to allowing workers to purchase equity in their employer under an ESPP or other arrangement such as reciprocal ownership, employer equity could be provided to offset earnings sacrifices. Such an arrangement would need to be provided within constraints of such things as minimum wage regulations. This may be a better option than such traditional options as capital markets or labor reduction.

An equity pool could be created to offset short-term wage reduction for future redemption. In situation when employees or contractors must take reductions in pay because of business pressures, they may be provided equity or options to compensate for such reductions.

It may be valuable to integrate union-like features into systems and methods. Options are made available to bring all stakeholders together around a common goal or issue. However, instead of a one-size fits all solution, the present disclosure provides a framework in which tradeoffs and inputs are considered at an individual level. Systems and methods allow for individual workers to make choices based on their personal and family situations. Some considerations for employer and worker may be short term such as dealing with emergencies and liquidity needs. Other considerations may be of a long-term nature such as tax issues with retirement accounts, phases of life for the individual workers, and their generosities.

In the context of mergers and acquisitions, workers are often adversely affected when their employer is taken over by another company. In an extension of the union-like features mentioned above, workers and employer may enter into shared sacrifices to achieve a more optimal deal such that jobs are preserved while management achieves its objectives.

In an example, if the cost of an acquisition would normally be $15 million, labor costs might be used to reduce transactions costs. The tradeoff on employee cash compensation could be the equalizing factor in such a situation. Tradeoffs might be resolved in a hierarchy based on tax efficiency and resolving cash compensation at a late stage because it is often the least tax efficient.

The union-like features described herein may be extended further to include dating or friendship applications or apps. Such apps may be associated with various types of valued-added transactions, informal or formal business relationships (for example partnerships, joint ventures, or collaborations that may involve influencers) or individuals wherein the transactions may not involve monetary exchange. For example, a continuation-in-part patent may be a dating/friendship app or involve organized sports. Systems and methods provided herein consider tangible and intangible assets and liabilities of all stakeholders. As noted, a principal objective is to optimize transactions based on aggregate utility and collective benefit with financial and non-financial outcomes receiving appropriate emphases and weights given the nature of the transactions.

In an embodiment, systems and methods may provide for an arrangement involving concurrent employee and contractor status for a worker. A worker may be treated as an employee and receive a straight base salary and be obligated to file a W-2 form but also concurrently receive compensation as a contractor and be paid hourly for some periods and therefore file a 1099 form. For example, the worker may be compensated at minimum wage for baseline activities and then additional work is paid on an hourly basis. A worker in Massachusetts, for example, early the year 2023 where the minimum wage is $15.00 per hour may be paid $600.00 ($15/hour×40 hours) as a flat weekly wage. The worker may then receive $22.50 or $30.00 per hour as overtime pay for work associated with a different and perhaps more challenging set of duties when working beyond forty hours, for example on weekends or in the evening in a more demanding role. The present disclosure provides for such a concurrent or hybrid arrangement.

In an embodiment, a method for ensuring fairness in compensation to employees and contractors of an organization is provided. The method comprises a computer determining a total budgeted cost for a time period associated with a job description at an employer. The method also comprises the computer subtracting non-cash costs from the budgeted cost for exempt employees subject to the description to calculate an employee periodic cash cost. The method also comprises the computer subtracting non-cash costs from the budgeted cost for non-exempt employees subject to the description to calculate a contractor periodic cash cost. The method also comprises the computer determining an annual salary for employees based on the employee periodic cash cost. The method also comprises the computer determining a bi-weekly wage for contractors based on the contractor periodic cash cost. The method also comprises the computer publishing annual salary information and bi-weekly wage information for use in communication regarding compensation and benefits of employee status and contractor status at the employer.

The method also comprises the computer publishing the information for use by prospective employees and contractors. The method also comprises the computer publishing the information for use by existing employees and contractors considering transitioning from one of employee status to contractor status and vice versa.

The method also comprises the computer facilitating transitioning based on at least one of actual observed changes in business volume and projected changes in business volume. The method also comprises the computer selectively offering non-cash benefits to compensate for actual and perceived differences between benefits provided to employees and benefits provided to contractors.

The method also comprises the computer offering as a non-cash benefit low interest loans to employees and contractors to purchase equity in the employer. The method also comprises the computer offering participants opportunities to at least one of borrow against balances of purchased equity using credit card mechanisms and liquidate balances of purchased equity using debit card mechanisms. The method also comprises the computer allowing for concurrent employee treatment and contractor treatment of a worker wherein the worker receives a base salary for baseline activities and an hourly wage for work beyond the baseline activities.

In another embodiment, a system for facilitating transition between employee status and contractor status at an employer is provided. The system comprises a computer and application executing thereon that receives a message from a client device associated with one of a current employee and a contractor of an employer, the message requesting transition between employee and contractor status, the message further requesting a not adverse impact to compensation arising from the transition. The system also determines that the user of the client device is eligible to make the requested transition. The system also determines that the requested transition will result in a reduction of periodic cash compensation to the user. The system also searches for methods of non-cash compensation to mitigate the reduction and provides a low-cost loan to purchase equity of the employer as mitigation. The low-cost loan is provided under an existing employee stock purchase plan (ESPP) offered by the employer. The system further offers the user opportunities to at least one of borrow against balances of purchased equity using credit card mechanisms and liquidate balances of purchased equity using debit card mechanisms.

The system provides a mechanism for employees and contractors to restate prior tax returns thus enabling claiming of losses against the company they become an owner in via the ESPP. The system adjusts incentives to make transitions and adjusts costs to make transitions based on at least one of changes in business volume, changes in tax laws, changes in health insurance costs, and location of employee or contractor. The system is directed to including all forms of compensation in presenting alternatives to the user and enabling the user to optimize benefits based on personal circumstances of the user.

In yet another embodiment, a method of shifting employee and contractor compensation to optimize benefits is provided. The method comprises a computer receiving a request from one of an employee and a contractor of an employer to convert cash compensation to equity purchases under an employee stock purchase plan (ESPP). The method also comprises the computer establishing an account containing equity of the employer purchased with cash provided by the employee or contractor. The method also comprises the computer establishing an apparatus enabling employee or contractor to borrow against the account via a credit card mechanism.

The method also comprises the computer further enables the employee to draw down the account via liquidation of equity in the account and receive associated funds via debit card mechanism. The method also comprises the computer requiring the employee or contractor to repay borrowing against the account by liquidating equity held in the account.

The method also comprises the computer allowing the conversion as part of a transition of an employee to contractor status or as part of a transition of a contractor to employee status. The method also comprises the computer allowing transition of status based on changes in business volume. The method also comprises the computer accounting for tax and accounting considerations in determining terms of the conversion of cash compensation to equity purchases by employees and contractors.

What is claimed is:

1. A method for ensuring fairness in compensation to employees and contractors of an organization, comprising:
a computer determining a total budgeted cost for a time period associated with a job description at an employer;
the computer subtracting non-cash costs from the budgeted cost for exempt employees subject to the description to calculate an employee periodic cash cost;
the computer subtracting non-cash costs from the budgeted cost for non-exempt employees subject to the description to calculate a contractor periodic cash cost;
the computer determining an annual salary for employees based on the employee periodic cash cost;
the computer determining a bi-weekly wage for contractors based on the contractor periodic cash cost, and
the computer publishing annual salary information and bi-weekly wage information for use in communication regarding compensation and benefits of employee status and contractor status at the employer.

2. The method of claim 1, further comprising the computer publishing the information for use by prospective employees and contractors.

3. The method of claim 1, further comprising the computer publishing the information for use by existing employees and contractors considering transitioning from one of employee status to contractor status and vice versa.

4. The method of claim 3, further comprising the computer facilitating transitioning based on at least one of actual observed changes in business volume and projected changes in business volume.

5. The method of claim 1, further comprising the computer selectively offering non-cash benefits to compensate for actual and perceived differences between benefits provided to employees and benefits provided to contractors.

6. The method of claim 5, further comprising the computer offering as a non-cash benefit low interest loans to employees and contractors to purchase equity in the employer.

7. The method of claim 6, further comprising the computer offering participants opportunities to at least one of borrow against balances of purchased equity using credit card mechanisms and liquidate balances of purchased equity using debit card mechanisms.

8. The method of claim 1, further comprising the computer allowing for concurrent employee treatment and contractor treatment of a worker wherein the worker receives a base salary for baseline activities and an hourly wage for work beyond the baseline activities.

9. A system for facilitating transition between employee status and contractor status at an employer, comprising:
a computer and application executing thereon that:
receives a message from a client device associated with one of a current employee and a contractor of an employer, the message requesting transition between employee and contractor status, the message further requesting a not adverse impact to compensation arising from the transition,
determines that the user of the client device is eligible to make the requested transition,
determines that the requested transition will result in a reduction of periodic cash compensation to the user,
searches for methods of non-cash compensation to mitigate the reduction, and
provides a low-cost loan to purchase equity of the employer as mitigation.

10. The system of claim 9, wherein the low-cost loan is provided under an existing employee stock purchase plan (ESPP) offered by the employer.

11. The system of claim 10, wherein the system further offers the user opportunities to at least one of borrow against balances of purchased equity using credit card mechanisms and liquidate balances of purchased equity using debit card mechanisms.

12. The system of claim 9, wherein the system provides a mechanism for employees and contractors to restate prior tax returns thus enabling claiming of losses against the company they become an owner in via the ESPP.

13. The system of claim 9, wherein the system adjusts incentives to make transitions and adjusts costs to make transitions based on at least one of changes in business volume, changes in tax laws, changes in health insurance costs, and location of employee or contractor.

14. The system of claim 9, wherein the system is directed to including all forms of compensation in presenting alternatives to the user and enabling the user to optimize benefits based on personal circumstances of the user.

15. A method of shifting employee and contractor compensation to optimize benefits, comprising:
a computer receiving a request from one of an employee and a contractor of an employer to convert cash compensation to equity purchases under an employee stock purchase plan (ESPP);
the computer establishing an account containing equity of the employer purchased with cash provided by the employee or contractor; and
the computer establishing an apparatus enabling employee or contractor to borrow against the account via a credit card mechanism.

16. The method of claim 15, wherein the computer further enables the employee to draw down the account via liquidation of equity in the account and receive associated funds via debit card mechanism.

17. The method of claim 15, further comprising the computer requiring the employee or contractor to repay borrowing against the account by liquidating equity held in the account.

18. The method of claim 15, further comprising the computer allowing the conversion as part of a transition of an employee to contractor status or as part of a transition of a contractor to employee status.

19. The method of claim 18, further comprising the computer allowing transition of status based on changes in business volume.

20. The method of claim 15, further comprising the computer accounting for tax and accounting considerations in determining terms of the conversion of cash compensation to equity purchases by employees and contractors.
